(19) United States
(12) Patent Application Publication
(10) Pub. No.: US 2010/0023413 A1
(43) Pub. Date: Jan. 28, 2010

(54) SYSTEM AND METHOD FOR CONDUCTING A FUNDRAISING EVENT

(75) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(73) Assignee: CASTINEIRAS COMPANIES, LLC, Farmington, CT (US)

(21) Appl. No.: 12/180,854

(22) Filed: Jul. 28, 2008

(51) Int. Cl. G06Q 30/00; G06Q 40/00

(52) U.S. Cl. 705/26; 705/40; 705/35

(57) ABSTRACT

A promoter raises funds for a beneficiary by forming a venture with the beneficiary wherein purchases by customers of products benefit the beneficiary. The promoter offers products for sale, receiving payments from customers for the products; and shares a portion of the payment with the beneficiary organization. In one embodiment, a fundraising website is employed to offer the products. In one embodiment, products are customized by the customer and/or by the beneficiary. The promoter may offer to the beneficiary promotional material that promotes purchases. The beneficiary organization and/or the promoter may send the promotional material to potential customers.

### BACKGROUND OF THE INVENTION

1. Field of the Invention

This invention relates generally to systems and methods for conducting a fundraiser and, in particular, to systems and methods for conducting a fundraiser for the benefit of others by offering custom products.

2. Description of Related Art

Traditional methods of conducting a fundraising event for organizations include, for example, bake sales, candy sales, product sales, raffles and solicitations for cash contributions. Often, these methods are promoted and/or carried out by volunteers who personally approach potential contributors. Such methods are highly labor-intensive and limited, since the extent to which volunteers can be asked to make such efforts is limited. Typically, the volunteers are members of the beneficiary. In addition, fundraising efforts can be tedious and/or time-consuming.

In some cases, volunteers are limited in their ability to promote fundraising efforts. For example, organizations within a secondary school (drama clubs, choirs, marching bands, athletic teams, and the like) often recruit students to raise funds for various activities, but the school may be reluctant to appear to be endorsing the consumption of unhealthy snacks such as candy, or to pressure students to engage in door-to-door solicitation.

Based on the foregoing, it is the general object of this invention to provide systems and methods for conducting fundraising that improve upon, or overcome the problems and drawbacks of, prior art systems and methods for conducting fundraising.

### SUMMARY OF THE INVENTION

The present invention resides in one aspect in a method for conducting a fundraising event to raise funds for a beneficiary. The method includes forming a merchandising venture between a promoter and the beneficiary wherein purchases by customers benefit the beneficiary. The promoter offers products for sale, receives payments from customers for the products; and shares a portion of the payments with the beneficiary.

According to one aspect of the invention, the method may include maintaining a fundraising website accessible to customers via the Internet where customers can review, order and pay for products. Optionally, the fundraising website is configured to accept orders for products that are customized by the customer and/or the beneficiary. For example, the fundraising website may be configured to receive from the customer personalizing content for the products.

Another aspect of the invention relates to offering to the beneficiary promotional material that promotes purchases of products at the fundraising website for the benefit of the beneficiary. The beneficiary and/or the promoter may send the promotional material to potential customers.

Various other optional aspects of the invention include allowing beneficiaries and customers to register, asking registered customers to invite third parties to become registered customers. The method may include offering customers an incentive to register, wherein the incentive comprises a gift to the customer in return for making a stated number or amount of purchases. The method may include providing a blogging site and/or a social networking site for customers and/or beneficiary contacts.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram of a system for conducting a fundraising event in accordance with one embodiment of the present invention; and

FIG. 2 is a simplified flow diagram depicting a method for registering a beneficiary such that a fundraising event may be conducted for the beneficiary, in accordance with one embodiment of the present invention.

In these figures like structures are assigned like reference numerals, but may not be referenced in the description of all figures.

### DESCRIPTION OF PREFERRED EMBODIMENTS OF THE INVENTION

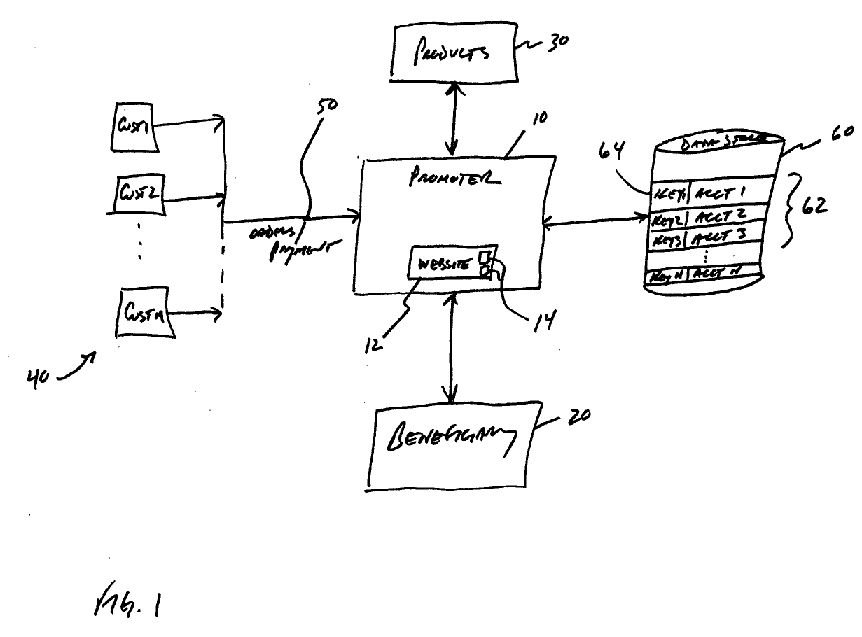

In accordance with one embodiment of the present invention illustrated in FIG. 1, a company or promoter 10 assists a beneficiary 20 in conducting an event to raise funds through the sale of products 30. The beneficiary 20 may wish to raise funds for its own use and may be, for example, a nonprofit organization such as a church, charity or an educational institution (e.g., a K-12 grade school), or the beneficiary 20 may be an individual who wishes to support a particular cause (e.g., an affinity group).

When the promoter 10 and the beneficiary 20 agree to terms under which a fundraising event is to be conducted, a merchandising venture is formed between the promoter 10 and the beneficiary 20. Typically, the fundraising event includes raising funds by offering to sell the products 30 to third party customers, e.g., Cust 1-Cust M shown generally at 40, collecting orders of and payments for the products 30 from the third party customers 40 as revenue, and sharing a portion of the revenue collected by the promoter 10 between the promoter 10 and the beneficiary 20 according to the terms of the merchandising venture. In one embodiment, some or all aspects of the merchandising venture may be formed and/or carried out between the promoter 10 and the beneficiary 20 over a communications network 50 such as, for example, on the public switched telephone network (PSTN) by means of toll free telephone number (e.g., 800 number) or over the Internet by means of a website 12 (a “fundraising website”) that is accessible by the beneficiary 20 through the use of a computing device operating internet browser software, as is generally known in the art. It should be appreciated that the communications network 50 includes wired and wireless communication channels between devices communicating thereon.

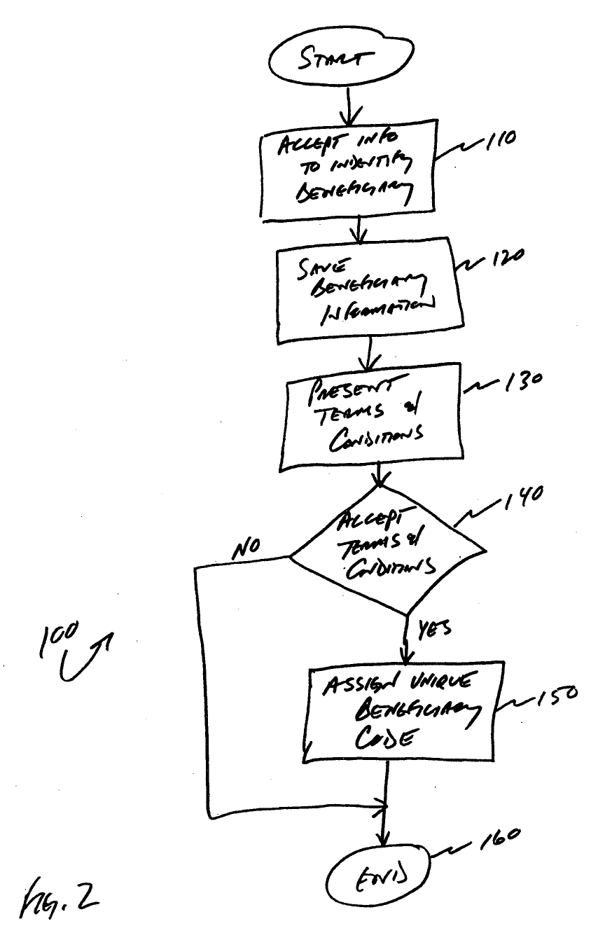

To allow the beneficiary 20 to form the merchandising venture online the fundraising website 12 is configured to include a process referred to herein as “beneficiary registration.” FIG. 2 depicts a beneficiary registration process 100 in accordance with one embodiment of the present invention. In Step 110 of the beneficiary registration process 100, the beneficiary 20 provides information needed to uniquely identify the beneficiary 20. For example, in the case of a beneficiary that is a school, the information to uniquely identify the school includes, for example, the name of the school, its address, a school administrator or other person that can represent the school's interest in establishing and conducting the fundraising event, and contact information including a telephone number and/or email address. At Step 120, the beneficiary information is optionally stored as a record in a data store 60 operatively coupled to the fundraising website 12. At Step 130, terms and conditions for conducting the merchandising venture between the promoter 10 and the beneficiary 20 are presented to the beneficiary 20 for review and approval. In one embodiment, the fundraising website 12 includes a virtual administrator (not shown) that guides the beneficiary 20 though the beneficiary registration process and provides, for example, answers to commonly asked questions. In yet another embodiment, the promoter 10 provides a toll-free telephone help line (if needed) to assist the beneficiary 20 during the beneficiary registration process 100 and/or during the course of conducting the merchandising venture. In one embodiment, the beneficiary registration process 100 includes a Step 140 whereby the beneficiary 20 indicates acceptance of the terms and conditions of the merchandising venture before the venture is formed between the promoter 10 and the beneficiary 20. If the beneficiary 20 rejects the terms and conditions, the registration process 100 ends at Step 160. If the beneficiary indicates acceptance of the terms of the merchandising venture, the beneficiary registration process 100 continues from Step 140 to Step 150. At Step 150, the beneficiary 20 is assigned a unique beneficiary code.

It should be appreciated that when initiating an order for one or more products 30 during a fundraising event, the fundraising website 12 is configured to request that the third party 40 initiating the order enters the unique beneficiary code corresponding to the beneficiary 20 that the third party 40 wishes to support with the purchase. Alternatively, the school or organization identities may be extracted from a barcode. As described in detail below, in one embodiment the data store 60 includes a plurality of accounts 62 that, for example, each correspond to a unique one of the beneficiaries 20. In one embodiment, the beneficiary code is a key 64 to the account corresponding to the beneficiary. The plurality of accounts 62 allow the fundraising website 12 to credit purchases to or, if necessary, debit refunds of returned items from a beneficiary account when a third party 40 purchases or returns a product or products 30 for the benefit of the beneficiary 20.

In one embodiment, at Step 150 a registration fee is payable to the promoter 10 by or on behalf of the beneficiary 20 to complete the beneficiary registration process 100. In one embodiment, the registration fee is collected electronically by credit card transaction, electronic check, wire transfer or the like. The beneficiary code remains active for a predetermined period of time such as, for example, one year, or as long as one or both of the promoter 10 and the beneficiary 20 wish to continue the merchandising venture. Optionally, the terms of the merchandising venture may include a discount in the registration fee paid by the beneficiary 20 based on, for example, the longevity of the merchandising venture relationship.

As described above, revenue from sales of products associated with a beneficiary are shared by the promoter 10 and the beneficiary 20 according to the terms and conditions of the merchandising venture. For example, a portion of the revenue that is distributed to the beneficiary 20 may vary with the amount that the beneficiary 20 initially pays the promoter 10 by means of the registration fee (e.g., a “registration level”). In one embodiment, the promoter 10 offers a “standard” registration level at a registration fee of, for example, about eighteen dollars ($18.00) per year, with which about ten percent (10%) of net revenue is distributed to the beneficiary 20; a “premium” registration level at a registration fee of, for example, about thirty-eight ($38.00) per year, with which about twenty percent (20%) of net revenue is distributed to the beneficiary 20; and an “exclusive” registration level at a registration fee of, for example, about forty-eight dollars ($48.00) per year, with which about thirty percent (30%) of the net revenue is distributed to the beneficiary 20. In one embodiment, the merchandising venture may be arranged such that within each of the different registration levels, a corresponding different level of services is provided by the promoter 10 to the beneficiary 20. For example, a different level of services may include a greater promotion of products associated with the beneficiary 20 that is registered at an exclusive level versus a lesser promotion of products associated with the beneficiary 20 that is registered at a standard level. The promoter can also be offered a monthly gift based on the money raised. The matching gift could be based on money raised within a period of time.

As noted above, the fundraising website 12 interacts with the data store 60 and, more particularly, with one of the plurality of accounts 62 as revenue is received during purchase transactions. At a predetermined timeframe such as, for example, quarterly, revenue is disbursed from the accounts 62 and distributed to the beneficiaries 20. Optionally, the plurality of accounts 62 are interest-bearing accounts and the revenue from purchases is deposited as principal into the accounts 62. In one embodiment, interest accrued on the principal accumulates to the benefit of the beneficiaries 20. In another embodiment, the interest accumulates to the benefit of the promoter 10 and is retained as, for example, a service fee for administrating the plurality of accounts 62.

In one embodiment, the fundraising website 12 includes a plurality of web pages 14, each web page being dedicated to one of the registered beneficiaries 20. The dedicated beneficiary web page (e.g., a “beneficiary web page”) includes, for example, a description of the beneficiary 20 and a description of the one or more products 30 offered by the beneficiary 20. In one embodiment, the beneficiary 20 participates in the construction and maintenance of the beneficiary web page by, for example, entering and/or uploading content to the beneficiary web page on an initial or periodic basis. In one embodiment, the fundraising website 12 is configured to include one or more templates that can be retrieved and modified by individual beneficiaries to “customize” its own beneficiary web page.

In one aspect of the present invention, the fundraising website 12 provides a plurality of products (e.g., the products 30) that may be customized, for example, with a logo, image(s), message, or the like, from the beneficiary 20 to provide products 30 that are uniquely identifiable with the beneficiary 30 and/or a particular cause of interest to the beneficiary and featured during a particular fundraising event. For example, the fundraising website 12 allows for a text-based customization on products to further customize or personalize items that are suitable as a gift for a holiday, special occasion and/or a group-based fundraising product such that a single product is mass-produced for sale in large quantities at a specific time or during a specific fundraising event. In one embodiment, the promoter 10 (e.g., via the fundraising website 12) offers one-at-a-time personalized gifts that may be of value as priceless by friends and family. For example, a school as a beneficiary 30 decides to produce its mascot on a T-shirt (or like product) and mass produce and distribute the T-shirt. Similarly, a parent interested in, for example, benefiting a child's school, scans in, uploads or otherwise provides images that are affixed to provide a special gift such as, for example, a coffee mug, T-shirt, playing card, puzzles, tiles, key chain, luggage tag, apron, etc., featuring their child in his/her school photo, the child's original artwork, and the like. The parent may then inform family and friends to access the fundraising website 12 and purchase the special gift both to receive a special gift and to ensure that a portion of the revenue from the sale of the special gift benefits the child's school.

In one embodiment, the fundraising website 12 is configured to permit a third party 40 to access images from another fundraising venture such as, for example, an image used for customized postage stamps sold as a fundraiser as described in U.S. patent application Ser. No. 11/396,895, filed Apr. 3, 2006, and published as U.S. Patent Application Publication No. 2006/0293910. The disclosure of this U.S. patent application Ser. No. 11/396,895 is incorporated herein by reference in its entirety. In this example, the other fundraising venture includes a roster of artists and/or images for use on, for example, custom postage stamps, and the fundraising website 12 permits the third party 40 to access the images on the roster for use in customizing products. In one embodiment, the third party 40 enters, for example, an identification number for artist (which may then provide access to a menu of images from that artist) or for a particular image.

In one embodiment, the promoter 10 provides promotional materials corresponding to the fundraising event, products 30, and the like, that the beneficiary 20 forwards to third parties 40 (e.g., potential customers). For example, the promoter 10 (via the fundraising website 12) provides beneficiaries 20 with access to the promotional materials including tools, marketing promotions, and a suggested promotion strategy, that the beneficiaries 20 use the tools, promotions, and the like to initiate the fundraising event. In one embodiment, the promoter 10 may optionally provide an electronic mail (email) message as a reminder to the beneficiary 20 to send an email messages promoting the fundraising event to the beneficiary's contacts. A recommended frequency of distributing such promotional messages may include, for example, distributing two emails messages per month during the course of a fundraising event to encourage sales. In one embodiment, the promotional message may include an attached suggested promotional message for use by the beneficiary. In one embodiment, the promotional messages may notify the beneficiary 20 at predetermined time periods such as, for example, about one week in advance of a prescribed release. As can be appreciated, each beneficiary independently determines if they want to send the email promotion at all, within the recommended timeframes or not at all.

In one aspect of the invention, the promoter 10 may offer to promote sales of the products 30 for a fee. In one embodiment, the beneficiary 20 conveys to the promoter 10 contact information for a list of third parties 40 that the beneficiary 20 believes may have interest in purchasing products, for example, are possible customers of the products (referred to herein as “beneficiary contacts”). The beneficiary contacts may include past or likely future contributors to the beneficiary 20. If the beneficiary 20 is an organization, beneficiary contacts may include, for example, members of the organization. If the beneficiary 20 is a primary or secondary school, the beneficiary contacts may include, for example, parents of the students attending the school, with a large percentage of the contacts (e.g., at least about seventy percent (70%)) of the beneficiary contacts being mothers of students attending the school. The promoter 10 may then participate in promoting the sale of products by sending promotional messages directly to beneficiary contacts and/or other third parties. In one embodiment, the promoter 10 may allow the beneficiary 20 to preview, edit and/or approve promotional messages before sending the messages to the third parties 40. The promoter 10 may also forward to third parties 40 messages composed by the beneficiary 20.

In one internet-based embodiment of this invention, the fundraising website 12 allows the beneficiary 20 to choose whether, or to what extent, to authorize the promoter 10 to directly communicate with third parties 40 regarding the sale of products 30 to benefit the beneficiary 20. For example, the fundraising website 12 may be configured to allow the beneficiary 20 to upload an electronic list of beneficiary contacts (preferably with contact information that includes email addresses) and to allow the beneficiary 20 to request (optionally, for a fee) an automated promotion package. The automated promotion package periodically promotes the sale of products 30 to the beneficiary contacts by distributing email messages to the beneficiary contacts. In one embodiment, the promotional emails (or other types of communication) to the beneficiary contacts are customized to the beneficiary and/or specific fundraising event and may include details such as the beneficiary name, logo, special incentives and promotions, etc.

Alternatively, or in addition to the foregoing promotion strategies, the promoter 10 may promote sales of product 30 to third parties 40 independently of the beneficiary 20.

The process of selling products may include collecting and recording personal profile information about the third parties 40 as customers. The personal profile information may be used to target or select customers to receive, or gain access to, special offers and promotions pertaining to the merchandising venture or to other offers that may be deemed of interest to the third party based on, for example, records of previous purchases.

In one embodiment, email promotional messages may be provided by the promoter 10 in traditional text format and/or in HTML format (as is known in the art) and may include animated announcements from a pre-selected promotional personality such as, for example, personality characteristics of well known human or animated characters such as the fabled Seven Dwarfs. A variety of formats may be employed, and the promotional personalities may be used randomly to drive the third party/customer interest up when they are sent. The timing and content of promotional message may also be bases around key holidays such as Valentines Day, Mothers Day, Fathers Day, Christmas, Hanukah, and the like.

In one embodiment, the fundraising website 12 is configured for interactive use by the third parties 40. For example, the fundraising website 12 may be configured to require, as a condition of purchase, that the third party 40 buyer agrees to necessary terms and conditions of the fundraising website 12 such as, for example, to provide personal profile information consisting at least contact information, and to assent to the sharing of revenue from purchased products to the associated beneficiary 20. For example, the fundraising website 12 may be configured to collect wire transfer data to electronically transfer the sales revenue to an account (e.g., one of the accounts 62) maintained for the beneficiary 20. The fundraising website 12 may also be configured to collect and store personal profile information about the third party 40 product buyer in the data store 60. In one embodiment, as a purchase, the third party (e.g., customer) receives a confirmation email from (or on behalf of) the beneficiary 20 acknowledging and, for example, thanking the third party 40 for making the purchase. In one embodiment, the third party 40 may be encouraged to promote further sales of products 30 for a beneficiary 20 and/or to promote the services of the promoter 10 to others via email.

The promoter 10 may invite third parties 40 to register with the promoter 10 (optionally via the fundraising website 12), and a Customer Registration Process (similar to the registration process 100) may optionally require the third party 40 to provide more personal profile information than is required to buy a product. The Customer Registration may be offered to non-buyers as well. By purchasing a product or by indicating a beneficiary during the Customer Registration Process, a registered customer becomes associated with a beneficiary 20. Optionally, the confirmation notice for a purchase of a product may invite a buyer to register as a customer and to extend the invitation to register to others such as friends and family. Customers may register at the fundraising website 12 through a very interactive, entertaining and engaging process. This may include an animated registration personality to assist the customer in the registration process. In one embodiment, the Customer Registration Process includes an assent to the terms and conditions of the fundraising website 12.

In one embodiment, the fundraising website 12 is used to provide registered customers (e.g., the third parties 40) at least some, optionally all, of the features of registration. For example, registered customers may be provided access to important discounts and special offers that are available on a national level, regional level, and at a personal level based on the customer's profile. Registration may include an opportunity to store credit card information. The credit card may be the primary medium for the registered customer to purchase products and receive cash prizes. A registered customer can make a one-time purchase, or credit card information may be stored by the fundraising website 12 (e.g., in a customer record in the data store 60) to facilitate future purchases by that customer over time. An incentive to register may include free items such as, for example, luggage tags, that are earned after a predetermined number of purchases, e.g., after two or more purchases.

In one embodiment, the fundraising website 12 may offer the third parties 40 (such as registered customers) and, optionally, to unregistered customers, access to a topic-specific blog site and/or to an online social network. Blog topics may include, for example, one or more of education, fundraising, homework assistance, raising children, help needed when moving to a new area, and the like. Registered customers may have access to new product promotions, discounts, services, and the like. The registered customers may also be able to select one or more preferences for receiving relevant promotions (e.g., by direct mail, electronic mail, or both) rather than receiving all promotions that can be seen as merely being inundated with “junk mail.”

The fundraising website 12 may also generate income in conventional ways such as, for example, by displaying advertising (e.g., banner ads), sponsored links, and the like. Such income may go exclusively to the promoter 10 or may be shared with one or more of the beneficiaries 20.

### One Embodiment of Conducting a Preferred Fundraising Event Follows.

A school organization as a beneficiary 20 (e.g., “The ABC School”) enters into a merchandising venture with the promoter 10. Third party customers 40 review and place orders for products online at the fundraising website 12 and/or at a web page dedicated to the ABC School. The orders include a beneficiary code that uniquely identifies the beneficiary to the promoter 10. Payments for purchases by the customers are made directly to the promoter 10 and transferred to an on-line account registered by and assigned to the ABC School (e.g., one of the plurality of accounts 62) to hold revenue to be distributed to the ABC School. As described above, the account retains the revenue until a predetermined time for disbursement, e.g., quarterly. Any interest earned on the account is retained by the promoter 10 as a source of revenue. The promoter 10 records and periodically audits revenue flow and the plurality of accounts 62. While acting in an administrator capacity, the promoter 10 does not have authority to withdraw revenue from the ABC School account except as defined under the terms and conditions of the merchandising agreement formed between the promoter 10 and ABC School as the beneficiary 20.

In the exemplary fundraising event, as of a scheduled disbursement date, The ABC School has total sales of five thousand dollars ($5,000.00), with total shipping and handling (S&H) fees collected of four hundred dollars ($400.00) and interest earned on funds in THE ABC School's account of twenty-five ($25.00), for a total dollar value of five thousand four hundred twenty-five dollars ($5,425.00) within The ABC School's account. The terms and conditions of the merchandising venture in place between the promoter 10 and the ABC School as beneficiary 20 are that payment to the beneficiary will be thirty percent (30%) of the total sales revenue, which is exclusive of S&H fees and earned interest.

The promoter 10 receives payment on an ongoing basis as offers are placed by third part customers 40. Assume that the cost of purchasing (from a vendor) the products sold is fifty percent (50%) and the proportionate level of S&H fees collected versus actually paid is ninety percent (90%). A revenue calculation is performed as follows:

Sales: $5000×50%=$2500.00;

S&H: $400×90%=$360.00.

A vendor that actually provides the products sold receives $2860.00, which includes $2500.00 (product cost)+$360.00 (S&H actual spent) over the quarterly period of three months as orders are produced and filled.

The remaining balance at the end of the quarter would be an amount “earned” after vendor costs are satisfied, or:

Earned: $2565.00, which includes $2500.00 (net from product)+$40 (net from S&H fees collected)+$25 (interested earned on total revenue in the account).

Accordingly, the promoter 10 directs processing of the following disbursement:

Beneficiary 20: $1,500.00, which is 30% of the total sales ($5,000.00×30%);

Promoter 10: $1,065.00, which includes $1,000 from revenue earned ($2500−$1,500)+$40 from S&H+$25 for earned interest.

Although not described in the example above, any advertising revenue generated by the fundraising website 12 is retained by the promoter 10. The purchases are expected to be non-taxable transaction as the beneficiary 20 is a qualifying nonprofit organization. Accordingly, the “revenue flow” is expected to create a non-taxable event as the beneficiary 20 is a qualifying nonprofit entity and customers 40 are making purchases from a not-for-profit institution, while back office administrative and accounting services and the like are being provided by the promoter 10.

It should be appreciated that perceived advantages of the present invention are seen to include providing a highly efficient fundraising method, e.g., a fundraising method that requires less effort by a beneficiary than prior art methods. In addition, an Internet-based embodiment is designed to be highly entertaining and valuable to the end customers. For example, the invention is particularly well-suited to raising funds for schools because it does not require expressly involve students or require them to solicit door-to-door. Moreover, products 30 may be selected to enhance key values such as, for example, health by not including sugar-based products such as candy which have heretofore dominated certain school fundraisers. Products 40 may also be selected to not include “extreme margin—low value” products (which are often regarded as “junk” by customers).

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A method for conducting a fundraising event to raise funds for a beneficiary, comprising:
forming a merchandising venture between a promoter and the beneficiary wherein purchases by customers benefit the beneficiary;
offering products for sale;
receiving payments from customers for products; and
sharing a portion of said revenue with the beneficiary.

2. The method of claim 1, further comprising:
maintaining a fundraising website accessible to customers via the internet where customers can order and pay for products.

3. The method of claim 2, wherein the fundraising website is configured to accept orders for products that are customized by at least one of the beneficiary and the customer.

4. The method of claim 3, wherein the fundraising website is configured to receive from the customer personalizing content for the products.

5. The method of claim 1, further comprising:
offering to the beneficiary promotional material that promotes purchases of products at the fundraising website for the benefit of the beneficiary.

6. The method of claim 1, further comprising:
sending promotional messages to potential customers for purchases of products at the fundraising website for the benefit of the beneficiary.

7. The method of claim 1, wherein forming the merchandizing venture includes receiving from the beneficiary a registration fee.

8. The method of claim 7, comprising:
offering to share a greater portion of payments received from the customers with the beneficiary in exchange for payment of a greater registration fee.

9. The method of claim 7, comprising:
offering to the beneficiary, in exchange for payment of a second registration fee, to send promotional messages to potential customers for purchases of products at the fundraising website for the benefit of the beneficiary.

10. The method of claim 9, further comprising
receiving from the beneficiary a list of beneficiary contacts; and
sending promotional messages to the beneficiary contacts to promote purchases of products at the merchandising website for the benefit of the beneficiary.

11. The method of claim 1 wherein the beneficiary is an educational institution.

12. The method of claim 1 wherein the beneficiary is a nonprofit institution.
